(19) United States
(12) Patent Application Publication
(10) Pub. No.: US 2023/0095285 A1
(43) Pub. Date: Mar. 30, 2023

(54) SYSTEMS AND METHODS FOR USE IN BIOMETRIC INTERACTIONS

(71) Applicant: MASTERCARD INTERNATIONAL INCORPORATED, Purchase, NY (US)

(72) Inventors: Mohamed Abouelenin, San Carlos, CA (US); Douglas C. Whiteside, O'Fallon, MO (US); Jonathan Robert Powell, San Juan Capistrano, CA (US); Ken Miura, Aurora (CA); Qing Cao, Purchase, NY (US)

(21) Appl. No.: 17/951,520

(22) Filed: Sep. 23, 2022

Related U.S. Application Data
(60) Provisional application No. 63/248,203, filed on Sep. 24, 2021.

(51) Int. Cl. G06Q 20/40; G06Q 20/38

(52) U.S. Cl. CPC G06Q 20/40145; G06Q 20/3821

(57) ABSTRACT

Systems and methods are provided for resolving biometric mismatches in connection with biometric interactions performed based on the biometric mismatches. One example computer-implemented method includes receiving a biometric mismatch alert from a first party for a biometric interaction, where the biometric mismatch alert includes a credential and a reason code, and identifying a biometric provider based on a requestor ID for the biometric interaction. The method also includes transmitting the biometric mismatch alert to the identified biometric provider and determining, based on a response to the biometric mismatch alert and at least one rule, whether to impose an offset on the biometric provider for the biometric interaction. The method then includes compiling and transmitting a reply to the biometric mismatch alert to the first party, wherein the reply indicates the offset being imposed, whereby the first party initiates an offset interaction to recoup an amount of the biometric interaction.

### CROSS-REFERENCE TO RELATED APPLICATION

This application claims the benefit of, and priority to, U.S. Provisional Application No. 63/248,203, filed Sep. 24, 2021. The entire disclosure of the above application is incorporated herein by reference.

### FIELD

The present disclosure is generally directed to systems and methods for use in (e.g., for use in facilitating, etc.) biometric interactions, for example, where biometrics of users are employed to initiate the interactions and, in particular, to resolving biometric mismatches that may arise in such biometric interactions.

### BACKGROUND

This section provides background information related to the present disclosure which is not necessarily prior art.

Users are known to initiate interactions with parties in various manners. For example, a user (e.g., a consumer, etc.) may present a credit card, or other payment device, to a merchant party, to initiate a payment account transaction to purchase a product or service from the merchant party, whereby the transaction is funded by an account associated with the credit card (or other payment device).

### DRAWINGS

The drawings described herein are for illustrative purposes only of selected embodiments and not all possible implementations, and are not intended to limit the scope of the present disclosure.

FIG. 1 is an example system of the present disclosure suitable for use in resolving biometric mismatches among parties in connection with biometric interactions involving the parties;

FIG. 2 is a block diagram of an example computing device that may be used in the system of FIG. 1; and

FIG. 3 is an example method, which may be implemented in connection with the system of FIG. 1, for use in resolving a biometric mismatch forming a basis for a biometric interaction.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

When users interact with merchants to purchase products (e.g., good, services, etc.), the users may pay for the products with payment accounts (e.g., by presenting payment instruments associated with the payment accounts to the merchants, etc.). Occasionally, the interactions, or more specifically, transactions, may be initiated based on biometrics of the users. For example, a user may present his/her fingerprint or facial image to the merchant, which is captured by the merchant and then converted (e.g., mapped, etc.), by one or more parties, to a payment account credential (e.g., a stored payment account credential, etc.) that is used in the transaction. From time to time, although rarely, the biometric may be matched incorrectly to an incorrect (or improper) user, giving rise to a biometric mismatch (e.g., at a biometric provider, etc.). In this instance, because the biometric is the basis for the payment account credential being identified, an incorrect payment account credential is identified and used in the transaction. When the user associated with the account used in the transaction discovers the improper use, it may be difficult to challenge the legitimacy of the transaction in certain instances.

Uniquely, the systems and methods herein provide for resolution of biometric mismatches, or disputes related to the same, whereby the responsibility is appropriately shifted to a biometric provider consistent with one or more rules. In particular, when a user identifies a biometric mismatch interaction to an issuer, the issuer submits a biometric mismatch alert to a dispute host. The dispute host identifies the biometric provider involved in the matching of the biometric and submits the alert to the biometric provider. The biometric provider is then enabled to investigate and provide details of the biometric match back to the dispute host. Thereafter, the dispute host applies one or more rules to the alert, and either requires a reimbursement or offset from the biometric provider or not (and notifies the issuer of the same). When the reimbursement or offset is required, the issuer submits a collection message for the reimbursement or offset the transaction, which is paid by the biometric provider.

In this manner, because the biometric provider is responsible for the biometric matching, the responsibility for the loss in the transaction associated with the biometric mismatch is allocated to the biometric provider. As such, the dispute server provides an enhancement to the flow of messaging related to disputes in biometric interactions, based on biometric mismatches in the interactions.

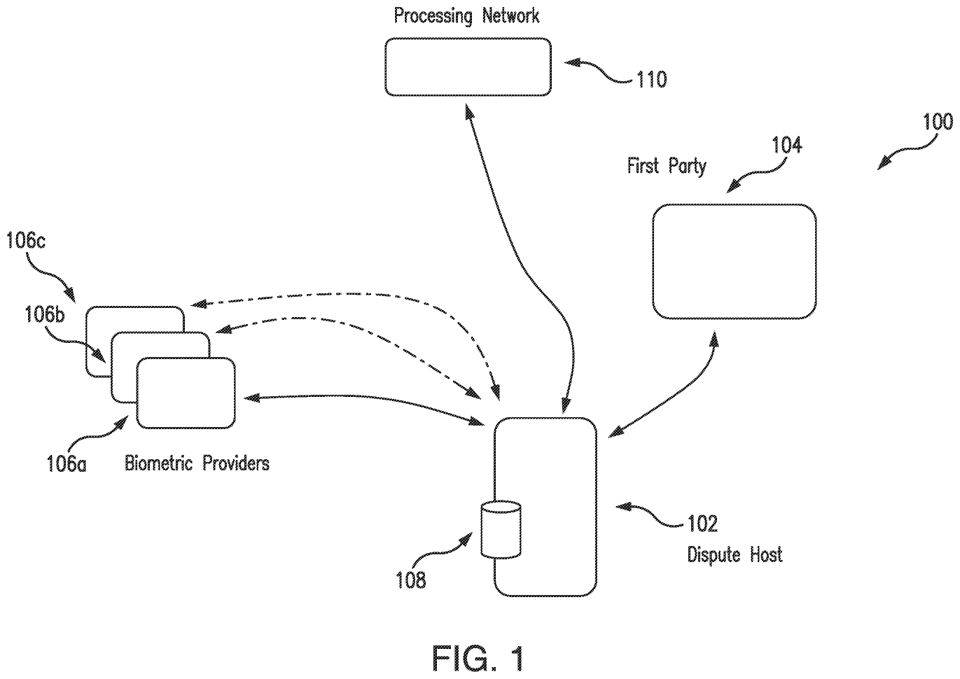

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships between users, providers, and parties; data privacy requirements and/or regulations; available biometric interactions; etc.

The illustrated system 100 generally includes a dispute host 102, a first party 104 (e.g., an account issuer party, etc.), and multiple biometric providers 106a-c, each of which is coupled in communication via one or more networks (e.g., as indicted by the arrowed lines, etc.). The one or more networks may each include one or more of, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

In this example embodiment, the dispute host 102 is configured to perform operations related to and/or involving biometric interactions associated with the first party 104, for example. The dispute host 102 may be a standalone party (e.g., an independent service, etc.), or the dispute host 102 may be incorporated into another party, such as, for example, a payment network, a financial institution, a biometric provider (e.g., the biometric provider 106c, etc.) or other related or suitable party, etc. In one particular example, the dispute host 102 may be incorporated, in whole or in part, in the processing network operated by Mastercard International Incorporated, etc. As shown in FIG. 1, the dispute host 102 includes a repository 108, which is configured to store biometric identity records, as described more below.

Also in this example embodiment, the first party 104 includes an issuer bank configured to issue payment accounts to users, where the payment accounts are used to fund transactions with merchants, for example, for the purchase of goods and/or services, etc. The payment accounts may be credit, debit, prepaid or other suitable accounts, etc. In general, the first party 104 (or issuer 104 hereinafter) is configured to receive authorization requests from a processing network 110 (e.g., the Interchange System operated by Mastercard International Incorporated, etc.), and to respond with approvals or declines as authorization replies, based on, for example, standing of the payment accounts involved in the transactions (and identified in the authorization requests), balances of the payment accounts, etc. The issuer 104 is also configured to cooperate with the processing network 110 to clear and settle the transactions after authorization.

Relatedly, the processing network 110 is configured to receive authorization requests from merchants or other parties initiating transactions, and then to pass the authorization requests to the respective issuers of the payment accounts involved in the transactions (e.g., the issuer 104, etc.). The processing network 110 is further configured to coordinate authorization reply messaging from the issuers (e.g., indicating approval or decline of the transactions, etc.) back to the merchants, and then to clear and settle approved transactions, etc.

The biometric providers 106a-c are each configured to register, directly or indirectly, users and their biometrics to be used in interactions by the users, whereby each of the biometric providers 106a-c is configured to store one or more biometric references (e.g., as reference biometric templates, etc.) for a user and a biometric identifier (ID) or other identifier of the user associated with the biometric reference. Each of the biometric providers 106a-c, then, is registered with the dispute host 102, along with any merchants, or more generally, requestors, of biometric transactions. In connection therewith, the biometric providers 106a-c may also compile, create, etc. backup biometric templates for the biometric references, for example, for use in connection with alerts as described herein (e.g., where the backup templates may be run or compared against reference templates to validate results, etc.).

In general, for a biometric interaction, a user presents a biometric at a merchant (not shown) in connection with purchasing a product, service, etc. from the merchant. The merchant captures the biometric from the user and submits the biometric (or form thereof) to one of the biometric providers 106a-c, directly or through another party (e.g., through a biometric identify service (BIS), etc.). In turn, the biometric provider 106b, for example, is configured to receive the biometric and to match the biometric to a biometric reference stored in a data structure of the biometric provider 106b, and to return the biometric ID associated with the matching biometric reference to the merchant, either directly or through an intermediary (not shown). It should be appreciated that the biometric providers 106a-c may compile and store a biometric match record in memory thereof, as evidence of the match and/or details of the match (e.g., transaction details relating to the match (e.g., a transaction ID, an amount, a merchant identification, etc.), etc.). The biometric ID is then used, by the merchant or intermediary (e.g., the BIS, etc.) to determine a payment account credential (e.g., a PAN, a fPAN, a token, etc.) for the payment account associated with the biometric ID. For example, the biometric providers 106a-c may be configured to interact with a commerce service (directly or through the BIS), to which the payment account credential is provisioned and through which the payment account credential is linked to the biometric ID.

Once the payment account credential is obtained (be it by the biometric provider 106b or the BIS), it is returned to the merchant. In response, the merchant is configured to submit an authorization request for the transaction, which includes the obtained payment account credential, a transaction ID, an amount, a time/date, a merchant name, a MCC for the merchant, an acquirer ID, etc. The authorization request is submitted by the merchant, via the processing network 110, which is configured to pass the authorization request to the first party 104 (or issuer 104 of the account used in the transaction). The first party 104 is configured to assess the request, and then compile an authorization reply, which includes data from the authorization request (e.g., the transaction ID, the payment account credential, etc.) and an approval (or decline) of the transaction, and transmit the authorization reply back to the merchant, via the processing network 110. The transaction is later cleared and settled, whereby the first party 104 provides the amount of the transaction to the merchant, via the processing network 110, to fund the transaction.

That said, when the biometric provider 106b, in the example above, matches the biometric to a biometric reference, it is possible for the biometric provider 106b to match the biometric to the wrong biometric reference, i.e., a biometric mismatch. In connection therewith, when a user associated with the payment account charged (incorrectly) for the transaction identifies the transaction, the user (not shown) submits a claim to the first party 104 (e.g., the issuer of his/her payment account, etc.).

In connection therewith, in the illustrated embodiment, in response to such a claim, the first party 104 is configured to submit a biometric mismatch alert to the dispute host 102. The alert may include, in this example, without limitation, one or more of an amount of the transaction, a transaction ID for the transaction, a date/time of the transaction, the identified payment account credential, a reason code (e.g., biometric mismatch, etc.), merchant ID for the merchant involved in the transaction, and also a requestor ID (e.g., a token requestor ID or TRID, or other identifier (ID), etc.) for the merchant involved in the transaction. In general, the requestor ID is representative of the party that requested the biometric transaction, or more specifically, the party that requested the payment account credential (e.g., token, etc.) for use in the transaction. In connection therewith, when the requestor ID is included in the biometric mismatch alert, the dispute host 102 may be configured to validate the requestor ID, for example, based on a data structure (or look up table) of requestor IDs enrolled or registered for biometric interactions, etc., prior to taking further action based on the alert. That said, it should be appreciated that in other examples biometric mismatch alerts received from first parties may include other data/content. For example, in at least one embodiment, such a biometric mismatch alert does not include the requestor ID (whereby the requestor ID may instead be determined by the dispute host 102, upon receipt of the biometric mismatch alert, for example, based on the data structure (or lookup table) of requestor IDs, etc.).

The dispute host 102 is configured, in turn, to perform one or more checks on the alert (e.g., a frequency of the payment account, a duplicate alert involving the payment account, etc.) and then to identify a biometric provider associated with the requestor ID in the repository 108. In one example, the repository 108 of the dispute host 102 includes a mapping data structure between various requestor IDs and biometric providers (e.g., the biometric providers 106a-c, etc.). Table 1, for instance, illustrates an example mapping data structure that may be included in the repository, of various requestor IDs linked to the biometric providers 106a-c. For example, the requestor ID 123456789 is mapped to the biometric provider 106a, while the requestor ID 345678912 is mapped to the biometric provider 106b.

TABLE 1

| Requestor ID | Biometric Provider |
|---|---|
| 123456789 | Biometric Provider 106a |
| 234567891 | Biometric Provider 106c |
| 654789321 | Biometric Provider 106a |
| 345678912 | Biometric Provider 106b |

Based on the mapping data structure in the repository 108, then, the dispute host 102 is configured to identify the biometric provider 106b, for example, and to transmit the biometric mismatch alert (or part thereof) to the biometric provider 106b. In response, the biometric provider 106b is configured to perform one or more investigative operations, either automatically or manually. For example, the biometric provider 106b may be configured to retrieve a confidence score associated with the biometric match leading to the biometric mismatch alert. That is, the biometric provider 106b may be configured to locate a biometric match record (e.g., based on the transaction ID, transaction amount, merchant, etc.), which includes the confidence score, and to evaluate the confidence score (e.g., relative to a threshold, etc.). In connection therewith, the biometric provider 106b may re-calculate the confidence score for the interaction, to confirm accuracy of the prior (or original) score, and further perform a manual review of the prior score and/or the re-calculated score. The biometric provider 106b may also compare a reference biometric template used in generating the original confidence score to a backup template to confirm that the reference biometric template is accurate (e.g., and did not lead to an erroneous confidence score, etc.). The biometric provider 106b may further review, evaluate, etc. any additional metadata or secondary authentications used in conjunction with generating the original confidence score to confirm that the same was/were accurate. As a result of the investigation operations, the biometric provider 106b is configured to submit a response to the dispute host 102. The response may include the results of the investigation operations, such as, for example, evidence of the proper biometric match, etc. or, potentially, a confirmation of the mismatch.

The dispute host 102 is then configured to apply one or more rules to the alert, and determine whether to impose a reimbursement or offset for the biometric mismatch alert from the issuer 104. Rules may include, for example, exceeding a threshold number of alerts from (or involving) the payment account, exceeding a threshold number of alerts from the issuer 104, a history of mismatch alerts involving the biometric provider 106b, a history of mismatch alerts involving the user that submitted the claim, etc. Thereafter, the dispute host 102 is configured to transmit a reply to the issuer 104, which includes a determination to either impose the reimbursement or to not impose the reimbursement. Further, in some example embodiments, the reply from the dispute host 102 may also include an indication of an amount for the reimbursement that is attributed to each of the involved parties (e.g., where the dispute host 102 determines that responsibility for the mismatch should be attributed across multiple parties, for example, the issuer 104 and the biometric provider 106b; where agreement between the parties indicates that the parties will share responsibility in the reimbursement, etc.).

When the reimbursement or offset is imposed, the issuer 104 is configured to compile and submit a message to the processing network 110, where the message includes a fee collection message (e.g., a 1740 message, etc.), which includes a case identifier (e.g., a case ID, etc.) and an amount of the reimbursement, and other suitable data (e.g., account numbers for the involved parties, etc.). The issuer 104 then is able to recoup the amount of the biometric interaction (or an allocated portion thereof), which was the subject to the biometric mismatch. The processing network 110, in turn, is configured to facilitate the reimbursement and to notify the biometric provider 106b, in this example, of the reimbursement or offset being issued (and the amount thus debited from the account of the biometric provider 106b (if any)).

While explained above with reference to biometric provider 106b, it should be appreciated that the description is equally applicable to the biometric providers 106a and 106c. Also, it should be appreciated that while only one issuer 104 and three biometric providers 106a-c are included in FIG. 1, a different number of issuers, biometric providers, etc., may be included in other embodiments.

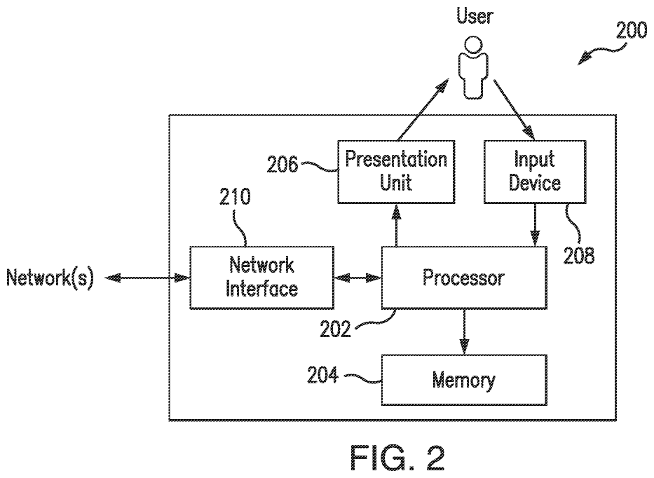

FIG. 2 illustrates an example computing device 200 that may be used in the system 100 of FIG. 1. The computing device 200 may include, for example, one or more servers, workstations, personal computers, laptops, tablets, smartphones, virtual devices, etc. In addition, the computing device 200 may include a single computing device, or it may include multiple computing devices located in close proximity or distributed over a geographic region, so long as the computing devices are specifically configured to function as described herein. In the example embodiment of FIG. 1, each of the dispute host 102, the issuer (or first party) 104, and the biometric providers 106a-c may include or may be implemented in a computing device consistent with the computing device 200 (coupled to (and in communication with) the one or more networks of the system 100). The repository 108 may also be considered, at least in part, a computing device consistent with the computing device 200. However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, biometrics, biometric records, biometric references, identifiers, mapping data structures, match records, mismatch alerts/records, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 and/or other computer system components configured to perform one or more of the various operations herein, whereby upon performance of the same the computing device 200 is transformed into a special purpose computer system. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, visually or audibly, for example, to a user of the computing device 200 (e.g., view options to submit a biometric mismatch alert, etc.) whereby the information may be displayed at (or otherwise emitted from) computing device 200, and in particular at presentation unit 206. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user of the computing device 200 (i.e., user inputs) such as, for example, directions to submit a biometric mismatch alert etc., as further described herein. The input device 208 may include a single input device or multiple input devices. The input device 208 is coupled to (and is in communication with) the processor 202 and may include, for example, one or more of a keyboard, a pointing device, a mouse, a camera, a biometric reader, a touch sensitive panel (e.g., a touch pad or a touch screen, etc.), another computing device, and/or an audio input device. In various example embodiments, a touch screen, such as that included in a tablet, a smartphone, or similar device, may behave as both the presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), or other device capable of communicating to one or more different networks herein and/or with other devices described herein. Further, in some example embodiments, the computing device 200 may include the processor 202 and one or more network interfaces incorporated into or with the processor 202.

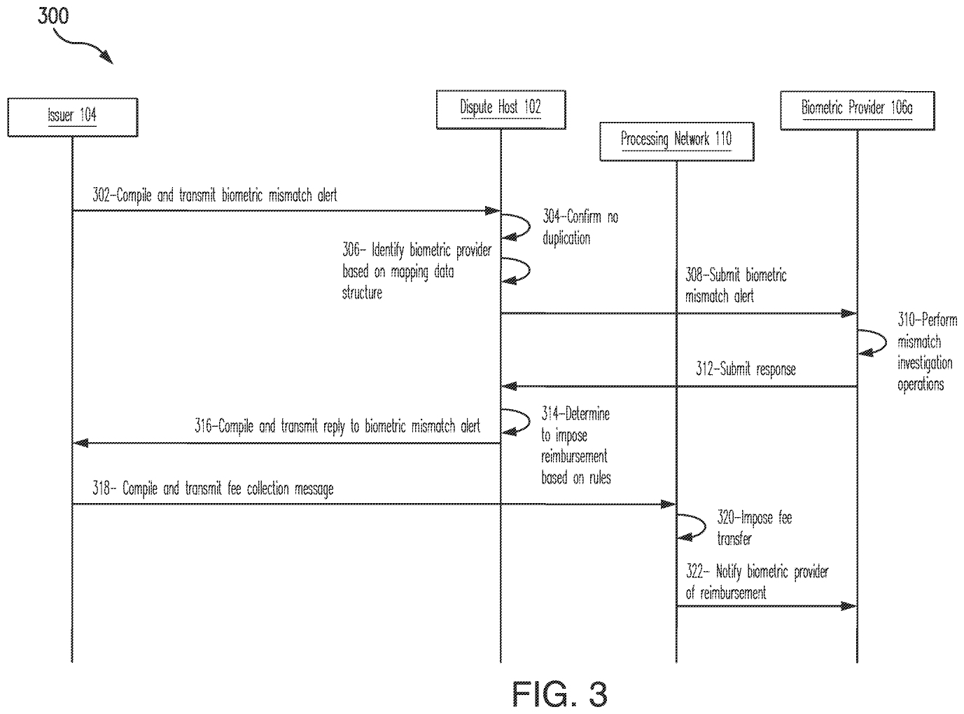

FIG. 3 illustrates an example method 300 for use in resolving a biometric mismatch that forms a basis for a biometric interaction. The example method 300 is described as implemented in the dispute host 102 and the other parts of the system 100, and also with reference to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

It should be appreciated, at the outset, that a biometric interaction (for example, a transaction herein) with a merchant has been completed, and the biometric match was performed by the biometric provider 106a, whereby a biometric match record is stored in memory of the biometric provider 106a (e.g., in memory 204 thereof, etc.). The biometric match record includes at least one of a transaction ID for the biometric interaction, a payment account credential, an amount for the interaction, and also a confidence score and/or other details about the biometric matching by the biometric provider 106a, etc.

That said, initially in the method 300, the issuer 104 receives a dispute notice from a user associated with a payment account that the transaction with the merchant (not shown) was not performed, or initiated, by the user. The issuer 104 may verify the transaction (e.g., other transaction(s) to the payment account at same time/date, but at a different location, etc.), assess the transaction history of the user and/or the payment account, etc., and decide the transaction is indeed a biometric mismatch. In response, at 302, the issuer 104 compiles and transmits, to the dispute host 102, a biometric mismatch alert for the transaction. The biometric mismatch alert may include, for example, one or more of a transaction ID for the interaction, an amount of the interaction, the payment account credential used in the interaction, a time/date of the interaction, a requestor ID (e.g., a TRID, other ID, etc.) for the merchant, and a reason code (e.g., indicative of biometric mismatch, etc.). It should be appreciated that the alert may include any combination of the above data or it may include other data, either as conventionally included in a transaction record, or as suitable to a biometric transaction or alert related to reimbursement.

In response, the dispute host 102 receives the alert from the issuer 104, checks that the reason code is indicative of a biometric mismatch, and then confirms, at 304, in this example, that the alert is not a duplicate of a prior alert. More broadly, the dispute host 102 may perform one or more different operations related to the alert to confirm, at least at this point, that the alert is proper. Apart from duplicate alerts, the dispute host 102 may further confirm that the date/time of the interaction are within a predefined interval for requesting reimbursement, that the data included in the alert is proper (e.g., that the data is not malformed, etc.), that the requestor ID is consistent with (e.g., in form, format, etc.) the biometric provider mappings provided herein (e.g., when included in the alert, etc.), that the requestor ID is associated with a valid merchant (e.g., when included in the alert, etc.), etc. Thereafter, the dispute host 102 retrieves (e.g., extracts, etc.) the requestor ID from the alert, when included, or otherwise retrieves (e.g., identifies, etc.) the requestor ID, for example, from a data structure of requestor IDs (e.g., in memory associated with the dispute host 102, etc.) associated with merchants enrolled or registered for biometric interactions (e.g., in memory associated with the dispute host 102, etc.), for example, based on details included in the alert (e.g., based on a merchant ID, etc.). The dispute host 102 then also identifies, at 306, the biometric provider employed for the biometric matching in the underlying interaction/transaction, based on the extracted/retrieved requestor ID and a mapping data structure in the repository 108 (e.g., Table 1, etc.). Once the biometric provider 106a, for example, is identified, the dispute host 102 submits, at 308, the biometric mismatch alert, in whole or in part, to the biometric provider 106a. Optionally, the dispute host 102 may generated a case ID for the alert, and append the case ID to the alert, prior to submitting the alert to the biometric provider 106a.

The biometric provider 106a then performs, at 310, one or more mismatch investigation operations. In particular, the biometric provider 106a locates the biometric record for the interaction/transaction based on, for example the transaction ID, the payment account credential, the time/date of the interaction, the name of the merchant, etc., alone or in combination, etc. The investigation operation(s) may then include confirming the biometric match, assessing a confidence score associated with the biometric match, etc. In connection therewith, the biometric provider 106b may re-calculate the confidence score for the interaction, to confirm accuracy of the prior (or original) score, and further perform a manual review of the prior score and/or the re-calculated score. The biometric provider 106b may also compare a reference biometric template used in generating the original confidence score (e.g., and as generated during registration of the corresponding user, etc.) to a backup template (e.g., as also generated during registration of the corresponding user, etc.) to confirm that the reference biometric template is accurate or not corrupt, etc. (e.g., and did not lead to an erroneous confidence score, etc.). The biometric provider 106b may further review, evaluate, etc. any additional metadata or secondary authentications used in conjunction with generating the original confidence score to confirm that the same was/were accurate. Additionally, the biometric provider 106a may append the case ID for the alert, if provided with the alert, to the biometric record for the interaction/transaction, for purposes of tracking and/or verification at a later time.

Next, the biometric provider 106a submits, at 312, a response to the dispute host 102. The response may include, for example, the confidence score of the match, or other data from the biometric record indicating that the match was appropriate (or not).

The dispute host 102 then determines, at 314, whether to impose a reimbursement (or offset), or not, based on one or more rules associated with the issuer 104, the biometric provider 106a, or otherwise, etc. In doing so, the dispute host 102 may access prior alerts (e.g., prior statistics relating to biometric mismatches, etc.) from the issuer 104, or prior alerts (e.g., prior statistics relating to biometric mismatches, etc.) directed to the biometric provider 106a, prior alerts involving the user that submitted the underlying claim and/or the user/biometric received in the interaction, etc. (e.g., to mitigate excessive biometric mismatch claims, and provide reporting/benchmarks as appropriate, etc.). The dispute host 102 may then utilize the data relating to the prior alerts and apply one or more rules to the current alert, and determine whether to impose a reimbursement or offset for the biometric mismatch alert from the issuer 104. In connection therewith, the rules may include, for example, the current alert exceeding a threshold number of total alerts from (or involving) the payment account, the current alert exceeding a threshold number of alerts from the issuer and/or biometric provider 106b, the current alert exceeding a threshold number of alerts involving the user that submitted the underlying claim or the user/biometric received in the biometric interaction, a history of mismatch alerts involving the issuer and/or biometric provider 106b and/or payment account and/or user, etc. After the dispute host 102 determines to impose, or not impose, the reimbursement, the dispute host 102 compiles and transmits, at 316, a reply to the biometric mismatch alert to the issuer 104. The reply includes data from the biometric mismatch alert, a determination with regard to the reimbursement (e.g., reimbursement imposed, or not; etc.), and the case ID (when generated).

When the reply from the dispute host 102 indicates that the reimbursement or offset is not to be imposed, the method 300 ends.

Conversely, when the reimbursement or offset is imposed, the issuer 104 compiles and transmits, at 318, a fee collection message to the processing network 110. The message includes, generally, fund transaction data (e.g., account numbers for the parties involved in the reimbursement or offset, party identifiers for the involved parties, etc.), and also includes the case ID and the amount in the memo field of the message. Upon received of the fee collection message, the processing network 110 imposes, at 320, the fee transfer, from an account of the biometric provider 106a to an account of the issuer 104. The issuer is then able to reimburse the payment account originally charged for the biometric transaction. Additionally, the processing network 110 notifies, at 322, the biometric provider 106a of the reimbursement. The notice includes one or more details of the transfer, and specifically, the amount and the case ID, in this example.

In this way, the present disclosure provides for a unique combination of features that enables use of conventional parties to biometric interactions to recoup amounts paid out based on errant biometric matching by biometric providers.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the recited steps and/or operations of the claims such as, for example: (a) receiving a biometric mismatch alert from a first party, the biometric mismatch alert including a credential and a reason code, the biometric mismatch alert specific to a biometric interaction; (b) in response to the biometric mismatch alert, retrieving a requestor ID for the biometric interaction; (c) identifying a biometric provider based on the requestor ID; (d) transmitting the biometric mismatch alert to the identified biometric provider; (e) receiving, from said biometric provider, a response to the biometric mismatch alert; (f) determining, based on the response to the biometric mismatch alert and at least one rule, whether to impose an offset on the biometric provider for the biometric interaction; and (g) compiling and transmitting a reply to the biometric mismatch alert to the first party, wherein the reply indicates the offset being imposed, whereby the first party initiates an offset interaction to recoup at least part of an amount of the biometric interaction.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in resolving a biometric mismatch in connection with a biometric interaction performed based on the biometric mismatch, the method comprising:
receiving, by a computing device, a biometric mismatch alert from a first party, the biometric mismatch alert including a credential and a reason code, the biometric mismatch alert specific to a biometric interaction;
in response to the biometric mismatch alert, retrieving a requestor ID for the biometric interaction;
identifying, by the computing device, a biometric provider based on the requestor ID;
transmitting, by the computing device, the biometric mismatch alert to the identified biometric provider;
receiving, by the computing device, from said biometric provider, a response to the biometric mismatch alert;
determining, by the computing device, based on the response to the biometric mismatch alert and at least one rule, whether to impose an offset on the biometric provider for the biometric interaction; and
compiling and transmitting, by the computing device, a reply to the biometric mismatch alert to the first party, wherein the reply indicates the offset being imposed, whereby the first party initiates an offset interaction to recoup at least part of an amount of the biometric interaction.

2. The computer-implemented method of claim 1, wherein the first party includes an issuer of a payment account involved in the biometric interaction; and
wherein the credential includes a credential specific to said payment account.

3. The computer-implemented method of claim 1, wherein identifying the biometric provider includes:
accessing a mapping data structure in a repository, the mapping data structure including various requestor IDs, each linked to one of multiple biometric providers; and
searching for the requestor ID in the mapping data structure.

4. The computer-implemented method of claim 1, wherein the biometric mismatch alert further includes a time/date of the interaction and a transaction ID for the interaction;
wherein only a portion of the biometric mismatch alert is transmitted to the identified biometric provider; and
wherein the portion of the biometric mismatch alert includes the time/date of the interaction and the transaction ID for the interaction.

5. The computer-implemented method of claim 1, wherein the response from the biometric provider includes a confidence score of a match between a biometric submitted for the biometric interaction and a biometric reference.

6. The computer-implemented method of claim 1, wherein the at least one rule includes a threshold number of mismatch alerts involving the credential, the first party, and/or the biometric provider.

7. The computer-implemented method of claim 1, further comprising:
receiving, by a processing network computing device, a fee collection message for the offset; and
imposing the offset between an account associated with the first party and an account associated with the biometric provider.

8. The computer-implemented method of claim 1, wherein the biometric mismatch alert includes the requestor ID; and
wherein retrieving the requestor ID includes extracting the requestor ID from the biometric mismatch alert.

9. The computer-implemented method of claim 1, wherein retrieving the requestor ID includes identifying the requestor ID from a data structure in memory associated with the computing device.

10. The computer-implemented method of claim 1, wherein the requestor ID includes a token requestor ID (TRID).

11. A non-transitory computer-readable storage medium comprising executable instructions for resolving a biometric mismatch forming the basis for a biometric interaction, which when executed by at least one processor, cause the at least one processor to:
receive a biometric mismatch alert from a first party, the biometric mismatch alert including a credential and a reason code, the biometric mismatch alert specific to a biometric interaction;
in response to the biometric mismatch alert, retrieve a requestor ID for the biometric interaction;
identify a biometric provider based on the requestor ID;
transmit the biometric mismatch alert to the identified biometric provider;
receive, from said biometric provider, a response to the biometric mismatch alert;
determine, based on the response to the biometric mismatch alert and at least one rule, whether to impose an offset on the biometric provider for the biometric interaction; and
compile and transmit a reply to the biometric mismatch alert to the first party, wherein the reply indicates the offset being imposed, whereby the first party initiates an offset interaction to recoup at least part of an amount of the biometric interaction.

12. The non-transitory computer-readable storage medium of claim 11, wherein the first party includes an issuer of a payment account involved in the biometric interaction; and
wherein the credential includes a credential specific to said payment account.

13. The non-transitory computer-readable storage medium of claim 11, wherein the executable instructions, when executed by the at least one processor to identify the biometric provider, cause the at least one processor to:
access a mapping data structure in a repository, the mapping data structure including various requestor IDs, each linked to one of multiple biometric providers; and
search for the requestor ID in the mapping data structure.

14. The non-transitory computer-readable storage medium of claim 13, wherein the biometric mismatch alert further includes a time/date of the interaction and a transaction ID for the interaction;
wherein only a portion of the biometric mismatch alert is transmitted to the identified biometric provider; and
wherein the portion of the biometric mismatch alert includes the time/date of the interaction and the transaction ID for the interaction.

15. The non-transitory computer-readable storage medium of claim 11, wherein the response from the biometric provider includes a confidence score of a match between a biometric submitted for the biometric interaction and a biometric reference.

16. The non-transitory computer-readable storage medium of claim 11, wherein the at least one rule includes a threshold number of mismatch alerts involving the credential, the first party, and/or the biometric provider.

17. The non-transitory computer-readable storage medium of claim 11, wherein the biometric mismatch alert includes the requestor ID; and
wherein the executable instructions, when executed by the at least one processor to retrieve the requestor ID, cause that at least one processor to extract the requestor ID from the biometric mismatch alert.

18. A system for resolving a biometric mismatch forming the basis of a biometric interaction, the system comprising at least one computing device configured to:
receive a biometric mismatch alert from a first party, the biometric mismatch alert including a credential and a reason code, the biometric mismatch alert specific to a biometric interaction;
in response to the biometric mismatch alert, retrieve a requestor ID for the biometric interaction;
identify a biometric provider based on the requestor ID;
transmit the biometric mismatch alert to the identified biometric provider;
receive, from said biometric provider, a response to the biometric mismatch alert;
determine, based on the response to the biometric mismatch alert and at least one rule, whether to impose an offset on the biometric provider for the biometric interaction; and
compile and transmit a reply to the biometric mismatch alert to the first party, wherein the reply indicates the offset being imposed, whereby the first party initiates an offset interaction to recoup at least part of an amount of the biometric interaction.

19. The system of claim 18, wherein the at least one computing device is further configured to:
access a mapping data structure in a repository, the mapping data structure including various requestor IDs, each linked to one of multiple biometric providers; and
search for the requestor ID in the mapping data structure.

20. The system of claim 19, wherein the response from the biometric provider includes a confidence score of a match between a biometric submitted for the biometric interaction and a biometric reference.
